(19) United States
(12) Patent Application Publication
(10) Pub. No.: US 2023/0348331 A1
(43) Pub. Date: Nov. 2, 2023

(54) RARE EARTH ALUMINATE SINTERED BODY AND METHOD FOR PRODUCING THE SAME

(71) Applicant: NICHIA CORPORATION, Anan-shi (JP)

(72) Inventors: Ryo YAMAMOTO, Anan-shi (JP); Shozo TAKETOMI, Tokushima-shi (JP)

(73) Assignee: NICHIA CORPORATION, Anan-shi (JP)

(21) Appl. No.: 18/310,949

(22) Filed: May 2, 2023

(30) Foreign Application Priority Data
May 2, 2022 (JP) 2022-075673

(51) Int. Cl. C04B 35/44

(52) U.S. Cl. CPC C04B 35/44; C04B 2235/3224; C04B 2235/3217

(57) ABSTRACT

A rare earth aluminate sintered body includes crystal agglomerated particles containing a rare earth aluminate fluorescent material crystal phase, and a rare earth aluminate crystal phase having a refractive index different from that of the rare earth aluminate fluorescent material crystal phase, wherein the rare earth aluminate crystal phase is arranged around the crystal agglomerated particles.

### CROSS-REFERENCE TO RELATED PATENT APPLICATION

This application claims priority to Japanese Patent Application No. 2022-075673, filed on May 2, 2022, the disclosure of which is hereby incorporated by reference in its entirety.

### BACKGROUND

The present disclosure relates to a rare earth aluminate sintered body, and a method for producing the same.

There are known light emitting devices provided with a light emitting diode (LED) or a laser diode (LD) and a wavelength conversion member including a fluorescent material that converts a wavelength of light emitted from the LED or LD. Such light emitting devices are used for applications such as lighting for vehicle, general lighting, backlights for liquid crystal display devices, and light sources for projectors.

As a wavelength conversion member provided in a light emitting device, for example, Japanese Unexamined Patent Publication No. 2017-197774 discloses a single-phase porous optoceramic material having a density in a specific range relative to the theoretical density.

When light is scattered by the porosity of the wavelength conversion member, the luminous flux of the wavelength conversion member tends to be reduced due to the density of the wavelength conversion member being reduced by the porosity, which may reduce the light extraction efficiency of the wavelength conversion member.

Thus, the present disclosure has an object to provide a rare earth aluminate sintered body capable of improving the light extraction efficiency, and a method for producing the same.

### SUMMARY

A first aspect of the present disclosure relates to a rare earth aluminate sintered body including crystal agglomerated particles containing a rare earth aluminate fluorescent material crystal phase, and a rare earth aluminate crystal phase having a refractive index different from that of the rare earth aluminate fluorescent material crystal phase, wherein the rare earth aluminate crystal phase is arranged around the crystal agglomerated particles.

A second aspect of the present disclosure relates to a method for producing a rare earth aluminate sintered body including: providing a first raw material mixture obtained by wet mixing raw materials and then drying; dry mixing the first raw material mixture and rare earth aluminate particles to obtain a mixture; molding the mixture to obtain a molded body; and calcining the molded body.

According to the aspects of the present disclosure, a rare earth aluminate sintered body capable of improving light extraction efficiency, and a method for producing the same, can be provided.

### BRIEF DESCRIPTION OF THE DRAWINGS

FIG. 1 is a flowchart describing a method for producing a rare earth aluminate sintered body.

FIG. 2 is a diagram illustrating a schematic configuration showing an exemplary light emitting device.

FIG. 3 is a plan view illustrating a schematic configuration showing an exemplary fluorescent material device containing a rare earth aluminate sintered body.

FIG. 4 is a lateral side view illustrating a schematic configuration of an exemplary fluorescent material device containing a rare earth aluminate sintered body.

FIG. 5 is a scanning electron microscope (SEM) micrograph of a rare earth aluminate sintered body according to Example 3.

FIG. 6 is an image view showing a state where grain boundaries of crystal agglomerated particles are separated in the SEM micrograph of the rare earth aluminate sintered body according to Example 3.

FIG. 7 is an SEM micrograph of a rare earth aluminate sintered body according to Comparative Example 3.

FIG. 8 is an image view showing a state where grain boundaries of crystal agglomerated particles are separated in the SEM micrograph of the rare earth aluminate sintered body according to Comparative Example 3.

FIG. 9 is a graph showing transmission spectra of rare earth aluminate sintered bodies according to Examples 1 and 2 and Comparative Example 1.

FIG. 10 is a graph showing transmission spectra of rare earth aluminate sintered bodies according to Examples 3 and 4 and Comparative Example 1.

FIG. 11 is a graph showing transmission spectra of rare earth aluminate sintered bodies according to Example 5 and Comparative Example 1.

FIG. 12 is a graph showing transmission spectra of rare earth aluminate sintered bodies according to Examples 6 and 7 and Comparative Example 1.

FIG. 13 is a graph showing transmission spectra of rare earth aluminate sintered bodies according to Examples 8 and 9 and Comparative Example 1.

### DETAILED DESCRIPTION

The rare earth aluminate sintered body and the production method according to the present disclosure will be hereunder described on the basis of embodiments. The embodiments described below are exemplifications for embodying the technical idea of the present disclosure, and the present disclosure is not limited to the following rare earth aluminate sintered body and production method. Standards according to Japanese Industrial Standard (JIS) Z8110 are applied to the relations between color names and chromaticity coordinates, and the relations between wavelength ranges of light and color names of monochromatic lights. In this specification, the “fluorescent material” is used in the same meaning as a “fluorescent phosphor”.

The rare earth aluminate sintered body includes crystal agglomerated particles containing a rare earth aluminate fluorescent material crystal phase, and a rare earth aluminate crystal phase having a refractive index different from that of the rare earth aluminate fluorescent material crystal phase, wherein the rare earth aluminate crystal phase is arranged around the crystal agglomerated particles. In the present specification, the rare earth aluminate sintered body may be referred to as “sintered body”. Also, in the present specification, the rare earth aluminate fluorescent material crystal phase may be referred to as “fluorescent material crystal phase”. When the rare earth aluminate crystal phase having a refractive index different from that of the fluorescent material crystal phase is arranged around the crystal agglomerated particles containing the fluorescent material crystal phase, the excitation light incident on the sintered body and the wavelength-converted light obtained by absorbing the excitation light in the fluorescent material crystal phase for wavelength conversion can be scattered at the interface between the fluorescent material crystal phase and the rare earth aluminate crystal phase having a refractive index different from that of the fluorescent material crystal phase. This can suppress the spread of light emitted from the sintered body. The rare earth aluminate sintered body is able to suppress the spread of light emitted from the rare earth aluminate sintered body, thereby enhancing the light extraction efficiency.

In the rare earth aluminate sintered body, two or more of the crystal agglomerated particles preferably present in one cross-sectional view, wherein the rare earth aluminate crystal phase is arranged between two or more of the crystal agglomerated particles. One cross-sectional view refers to viewing a surface or cross-section of a rare earth aluminate sintered body in an SEM micrograph measured using, for example, a scanning electron microscope (SEM). When the rare earth aluminate crystal phase is arranged between two or more of the crystal agglomerated particles, the excitation light that is incident on the sintered body and the wavelength-converted light that is wavelength-converted by the fluorescent material crystal phase can be easily scattered at the interface between the fluorescent material crystal phase and the rare earth aluminate crystal phase having a refractive index different from that of the fluorescent material crystal phase. This can suppress the spread of light emitted from the sintered body. The rare earth aluminate sintered body is able to suppress the spread of light emitted from the rare earth aluminate sintered body, thereby enhancing the light extraction efficiency.

The rare earth aluminate crystal phase preferably comprises and/or is derived from primary particles of a rare earth aluminate. The rare earth aluminate crystal phase formed from primary particles of a rare earth aluminate is said to be derived from primary particles of rare earth aluminate. When the rare earth aluminate crystal phase comprises and/or is derived from primary particles of a rare earth aluminate, the rare earth aluminate crystal phase is more likely to be arranged around the crystal agglomerated particles. Also, when the rare earth aluminate crystal phase comprises and/or is derived from primary particles of a rare earth aluminate, the rare earth aluminate crystal phase is more likely to be arranged between two or more of the crystal agglomerated particles.

The rare earth aluminate sintered body preferably includes crystal agglomerated particles having an absolute maximum length in a range of 10.0 μm or more and 150.0 μm or less on a surface or cross section of the rare earth aluminate sintered body. The absolute maximum length of the crystal agglomerated particles on a surface or cross section of the rare earth aluminate sintered body is more preferably in a range of 80.0 μm or more and 148.0 μm or less, and even more preferably in a range of 100.0 μm or more and 145.0 μm or less. When the absolute maximum length of the crystal agglomerated particles on a surface or cross section of the rare earth aluminate sintered body falls within the range of 10.0 μm or more and 150.0 μm or less, the excitation light incident on the sintered body can be easily absorbed on the fluorescent material crystal phase contained in the crystal agglomerated particles for wavelength conversion. This can suppress a decrease in luminous flux of light emitted from the sintered body and allows the light maintaining a high luminous flux to be emitted from the sintered body. The absolute maximum length of the crystal agglomerated particles refers to a distance between the two most distant points of a single secondary particle of crystal agglomerated particles that can be confirmed in a measurement range of a surface or cross section of the rare earth aluminate sintered body. Also, when the absolute maximum length of the crystal agglomerated particles on a surface or cross section of the rare earth aluminate sintered body falls within the range of 10.0 μm or more and 150.0 μm or less, the crystal agglomerated particles are larger than the rare earth aluminate crystal phase comprising and/or derived from the primary particles of the rare earth aluminate, and the rare earth aluminate crystal phase is more likely to be arranged around the crystal agglomerated particles. When the crystal agglomerated particles are larger than the rare earth aluminate crystal phase, the rare earth aluminate crystal phase is more likely to be arranged between two or more of the crystal agglomerated particles.

The measurement range area of the rare earth aluminate sintered body for measuring the absolute maximum length of the crystal agglomerated particles is preferably an area of 1,209,675 μm² in an SEM micrograph measured using a scanning electron microscope (SEM). When the measurement range for measuring the absolute maximum length of the crystal agglomerated particles on the surface or cross section of the rare earth aluminate sintered body is an area of 1,209,675 μm² in the SEM micrograph, the absolute maximum length of the crystal agglomerated particles can be accurately measured.

The rare earth aluminate sintered body preferably includes the rare earth aluminate fluorescent material crystal phase as a main phase and the rare earth aluminate crystal phase as a sub phase. In the present specification, the main phase refers to a crystalline phase present in a range of 51% by volume or more and 100% by volume or less relative to 100% by volume of a total volume of the main phase and the sub phase. When the rare earth aluminate fluorescent material crystal phase is the main phase and the rare earth aluminate crystal phase is the sub phase in the rare earth aluminate sintered body, the volume ratio of the crystal agglomerated particles containing the rare earth aluminate fluorescent material crystal phase is larger than that of the rare earth aluminate crystal phase, resulting in that the rare earth aluminate crystal phase is more likely to be arranged around the crystal agglomerated particles, and the rare earth aluminate crystal phase is more likely to be arranged between two or more of the crystal agglomerated particles.

In the rare earth aluminate sintered body, the content of the rare earth aluminate crystal phase preferably is in a range of 1.0% by volume or more and 10.0% by volume or less relative to 100% by volume of a total volume of the crystal agglomerated particles and the rare earth aluminate crystal phase. The content of the rare earth aluminate crystal phase is more preferably in a range of 1.2% by volume or more and 8.0% by volume or less, and even more preferably in a range of 1.5% by volume or more and 5.0% by volume or less, relative to 100% by volume of a total volume of the crystal agglomerated particles and the rare earth aluminate crystal phase. When the content of the rare earth aluminate crystal phase falls within the range of 1.0% by volume or more and 10.0% by volume or less in the rare earth aluminate sintered body, the rare earth aluminate crystal phase is more likely to be arranged around the crystal agglomerated particles, and the rare earth aluminate crystal phase is more likely to be arranged between two or more of the crystal agglomerated particles.

The rare earth aluminate fluorescent material crystal phase preferably contains at least one element selected from the group consisting of Y, La, Gd, Tb, and Lu. When the rare earth aluminate fluorescent material crystal phase contains at least one element selected from the group consisting of Y, La, Gd, Tb, and Lu, a rare earth aluminate fluorescent material crystal phase having a composition that can achieve absorption of incident excitation light and wavelength conversion into a desired wavelength can be easily obtained.

The rare earth aluminate fluorescent material crystal phase preferably has a composition included in a compositional formula represented by the following formula (I). When the rare earth aluminate fluorescent material crystal phase has a composition represented by the following formula (I), the rare earth aluminate fluorescent material crystal phase can absorb excitation light and emit light of which the wavelength is converted to a desired wavelength.

(R¹₁₋ₙCeₙ)₃(Al₁₋ₘM¹m)₅ₖO₁₂ (I)

wherein R¹ represents at least one element selected from the group consisting of Y, La, Lu, Gd, and Tb; M¹ represents at least one element selected from the group consisting of Ga and Sc; and m, n, and k each satisfy 0≤m≤0.02, 0.002≤n≤0.017, and 0.95≤k≤1.10.

In the composition represented by the formula (I), R¹ may include two or more rare earth elements. Ce is an activation element in the rare earth aluminate fluorescent material crystal phase, and the product of the parameter n and 3 represents a molar ratio of Ce in the composition represented by the formula (I). The parameter n is more preferably in a range of 0.002 or more and 0.016 or less (0.002≤n≤0.016), and even more preferably in a range of 0.003 or more and 0.015 or less (0.003≤n≤0.015). In the composition represented by the formula (I), the product of the parameter m, 5, and the parameter k represents a molar ratio of the element M¹. The element M¹ may not be included in the composition represented by the formula (I), that is, the parameter m may be zero (0). In the composition represented by the formula (I), the parameter m may be in a range of 0.00001 or more and 0.02 or less (0.00001≤m≤0.02), and may be in a range of 0.00005 or more and 0.018 or less (0.00005≤m≤0.018), in order to convert the wavelength for a desired color. In the composition represented by the formula (I), the product of the parameter k and 5 represents a total molar ratio of μl and the element W. The parameter k is more preferably in a range of 0.96 or more and 1.09 or less (0.96≤k≤1.09), and even more preferably in a range of 0.97 or more and 1.08 or less (0.97≤k≤1.08).

The rare earth aluminate crystal phase preferably contains at least one element selected from the group consisting of Gd, Tb, and Lu. When the rare earth aluminate crystal phase contains at least one element selected from the group consisting of Gd, Tb, and Lu, a rare earth aluminate fluorescent material crystal phase having a composition that absorbs incident excitation light and converts the wavelength into a desired wavelength can be easily obtained.

The rare earth aluminate crystal phase preferably has a composition represented by the following formula (II). When the rare earth aluminate crystal phase has a composition represented by the following formula (II), the rare earth aluminate crystal phase is more likely to be arranged around the crystal agglomerated particles, and the rare earth aluminate crystal phase is more likely to be arranged between two or more of the crystal agglomerated particles.

R²Al₁₋ⱼM²ⱼO₃ (II)

wherein R² represents at least one element selected from the group consisting of Gd, Tb, and Lu; M² represents at least one element selected from the group consisting of Ga and Sc; and j satisfies 0≤j≤0.02.

The rare earth aluminate sintered body preferably has a relative density of 90% or more. The relative density thereof is more preferably 93% or more, and even more preferably 95% or more; and may be 100%, may be 99% or less, and may be 98% or less. When the relative density of the rare earth aluminate sintered body falls within the range of 90% or more and 100% or less, the excitation light that is incident on the sintered body and the wavelength-converted light that is wavelength-converted by the fluorescent material crystal phase can be scattered at the interface between the fluorescent material crystal phase and the rare earth aluminate crystal phase having a refractive index different from that of the fluorescent material crystal phase. This can suppress the spread of light emitted from the sintered body.

The relative density of the rare earth aluminate sintered body can be calculated from an apparent density of the rare earth aluminate sintered body and a true density of the rare earth aluminate sintered body according to the following formula (1).

Relative density (%) of rare earth aluminate sintered body=(Apparent density of rare earth aluminate sintered body÷True density of rare earth aluminate sintered body)×100 (1)

The apparent density of the rare earth aluminate sintered body is a value obtained by dividing the mass of the rare earth aluminate sintered body by the volume of the rare earth aluminate sintered body, and can be calculated according to the following formula (2). The true density of the rare earth aluminate sintered body can be calculated according to the following formula (3) by using a true density of a rare earth aluminate fluorescent material and a true density of a rare earth aluminate. The voidage of the rare earth aluminate sintered body is the balance obtained by subtracting the relative density of the rare earth aluminate sintered body from 100%.

$$Apparent density of rare earth aluminate sintered body = Mass ( g ) of rare earth aluminate sintered body \div Volume ( {cm}^{3} ) of rare earth aluminate sintered body ( Archimede ’ s method ) \qquad ( 2 )$$

$$True density of rare earth aluminate sintered body = \frac{P {1}_{d} \times P {2}_{d} \times ( P {1}_{m} + P {2}_{m} )}{( P {2}_{d} \times P {1}_{m} ) + ( P {1}_{d} \times P {2}_{m} )} \qquad ( 3 )$$

Mass ratio (% by mass) of rare earth aluminate fluorescent material: P1ₘ True density (g/cm³) of rare earth aluminate fluorescent material: P1_{d} Mass ratio (% by mass) of rare earth aluminate particles: P2ₘ True density (g/cm³) of rare earth aluminate particles: P2_{d} P1ₘ+P2ₘ=100% by mass

The rare earth aluminate sintered body can be used as a reflection-type wavelength conversion member, in which the incident surface (first main surface) on which the excitation light is incident and the emitting surface (first main surface) from which the wavelength-converted light is emitted are the same. When the rare earth aluminate sintered body is used as a reflection-type wavelength conversion member, the thickness thereof is not limited. When the rare earth aluminate sintered body is a plate-shaped body, the plate thickness is preferably in a range of 90 μm or more and 250 μm or less, and more preferably in a range of 100 μm or more and 240 μm or less, in order to enhance the light extraction efficiency.

When the rare earth aluminate sintered body has a plate shape, and the incident surface on which the excitation light is incident and the emitting surface from which the wavelength-converted light is emitted are the same, the light diameter of the emitting light is preferably less than 100%, more preferably 95% or less, and even more preferably 94% or less, relative to 100% of the light diameter of the incident light. When the light diameter of the emitting light emitted from the same surface as the incident surface is less than 100% relative to 100% of the light diameter of the incident light, the spread of the emitting light is suppressed, and the light emitted from the rare earth aluminate sintered body can be converged on a desired position. The light diameter of the incident light that is incident on one surface of the rare earth aluminate sintered body is a light diameter of light emitted from a light source. The light diameter of the incident light can be measured using, for example, a color luminance meter. The light dimeter of the incident light is preferably in a range of 0.1 mm or more and 5 mm or less, and more preferably in a range of 0.5 mm or more and 4 mm or less. The light diameter of the emitting light emitted from the same surface as that on which the incident light is incident on the rare earth aluminate sintered body can be determined as follows: light emission luminance of the light emitted from the rare earth aluminate sintered body is measured using a color luminance meter; a position exhibiting the maximum luminance in the obtained light emission spectrum is defined as a center (measuring center); distances (mm) of two positions in the light emission spectrum where the luminance is 10/100 of the maximum luminance (hereinafter, may be referred to as “10/100 luminance”) from the measuring center are measured in terms of absolute values; and the sum of the absolute values of the distances (mm) of the two positions in the light emission spectrum where the luminance is 10/100 of the maximum luminance from the measuring center is determined as the light diameter of the emitting light.

A method for producing a rare earth aluminate sintered body includes: providing a first raw material mixture obtained by wet mixing raw materials and then drying; dry mixing the first raw material mixture and rare earth aluminate particles; molding a mixture obtained by dry mixing the first raw material mixture and the rare earth aluminate particles; and calcining a molded body obtained by molding the mixture.

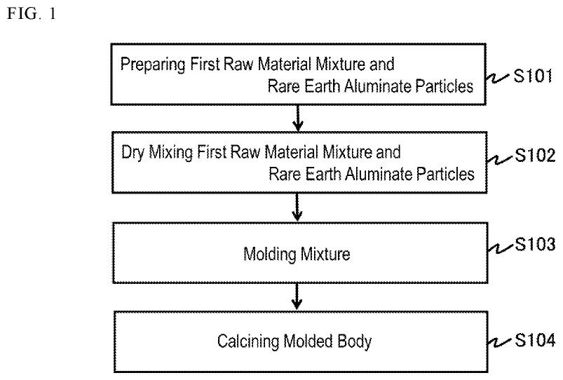

FIG. 1 is a flowchart describing an exemplary method for producing a rare earth aluminate sintered body. The method for producing a rare earth aluminate sintered body will be described with reference to FIG. 1. The method for producing a rare earth aluminate sintered body includes providing a first raw material mixture and rare earth aluminate particles S101, dry mixing the first raw material mixture and the rare earth aluminate particles S102, molding the mixture S103, and calcining the molded body S104.

The first raw material mixture is preferably provided to contain first oxide particles containing at least one rare earth element R′ selected from the group consisting of Y, La, Lu, Gd, and Tb, second oxide particles containing Ce, third oxide particles containing Al, optionally fourth oxide particles containing at least one element M¹ selected from the group consisting of Ga and Sc, and optionally rare earth aluminate fluorescent material particles.

Specific examples of the first oxide particles include yttrium oxide particles, lanthanum oxide particles, lutetium oxide particles, gadolinium oxide particles, and terbium oxide particles. Specific examples of the second oxide particles include cerium oxide particles. Specific examples of the third oxide particles include aluminum oxide particles. Specific examples of the fourth oxide particles include gallium oxide particles and scandium oxide particles.

The oxide particles contained in the first raw material mixture are preferably blended so as to have molar ratios in the composition represented by the formula (I).

When the oxide particles contained in the first raw material mixture are blended so as to have, for example, a molar ratio of the composition represented by the formula (I), the rare earth aluminate fluorescent material particles contained in the first raw material mixture preferably have the composition represented by the formula (I).

When the first raw material mixture contains rare earth aluminate fluorescent material particles, the mass ratio of the rare earth aluminate fluorescent material particles is preferably in a range of 10% by mass or more and 90% by mass or less, more preferably in a range of 15% by mass or more and 80% by mass or less, and even more preferably in a range of 30% by mass or more and 70% by mass or less, relative to 100% by mass of a total of the first oxide particles, the second oxide particles, the third oxide particles, and optionally the fourth oxide particles. When the first raw material mixture contains rare earth aluminate fluorescent material particles within the range of that mass ratio, the rare earth aluminate crystal phase can be arranged around the crystal agglomerated particles containing a rare earth aluminate fluorescent material crystal phase, thereby obtaining a sintered body containing crystal agglomerated particles having a desired size. The rare earth aluminate fluorescent material particles contained in the first raw material mixture may be rare earth aluminate fluorescent material particles formed by a coprecipitation method. The rare earth aluminate fluorescent material particles formed by a coprecipitation method have a large specific surface area and easily form crystal agglomerated particles containing a rare earth aluminate fluorescent material crystal phase.

In the first raw material mixture, raw materials are preferably wet-mixed. In the first raw material mixture, first to fourth oxide particles and optionally rare earth aluminate fluorescent material particles are wet-mixed to be uniformly dispersed in a liquid, thereby forming crystal agglomerated particles containing a homogeneous rare earth aluminate fluorescent material crystal phase. Examples of the liquid used in wet-mixing the first raw material mixture include deionized water, water, and ethanol. The amount of the liquid used in wet-mixing the first raw material mixture is preferably in a range of 10 parts by mass or more and 200 parts by mass or less, and may be in a range of 50 parts by mass or more and 150 parts by mass, relative to 100 parts by mass of the first raw material mixture.

The first raw material mixture obtained by wet mixing may contain a dispersant. Examples of the dispersant used include organic dispersants, such as a cationic dispersant, an anionic dispersant, and a nonionic dispersant. When adding a dispersant to the first raw material mixture, the amount of the dispersant is preferably an amount by which the dispersant volatilizes by thermal degreasing or calcining, and is preferably 10% by mass or less, may be 5% by mass or less, and may be 3% by mass or less, relative to 100% by mass of the first raw material mixture.

The first raw material mixture can be obtained by drying after the wet mixing. The drying temperature may be in a range of 50° C. or higher and 150° C. or lower, and the drying time may be in a range of 1 hour or more and 20 hours or less. By performing the wet mixing and drying, a first raw material mixture in which the raw materials of the first to fourth oxides and optionally added the rare earth aluminate fluorescent material particles are uniformly mixed can be obtained.

The rare earth aluminate particles are preferably provided by: wet mixing fifth oxide particles containing at least one element R² selected from the group consisting of Gd, Tb, and Lu, sixth oxide particles containing Al, and optionally added seventh oxide particles containing an element M² selected from the group consisting of Ga and Sc; and calcining a second raw material mixture obtained by the wet mixing at a temperature in a range of 1,000° C. or higher and 1,600° C. or lower. In the second raw material mixture, the fifth to seventh oxide particles are wet-mixed to be uniformly dispersed in a liquid, thereby forming rare earth aluminate particles containing a homogeneous rare earth aluminate crystal phase. The liquid used in wet-mixing the second raw material mixture can be the same liquid used in wet-mixing the first raw material mixture. The amount of the liquid used in wet-mixing the second raw material mixture is preferably in a range of 10 parts by mass or more and 200 parts by mass or less, and may be in a range of 50 parts by mass or more and 150 parts by mass, relative to 100 parts by mass of the second raw material mixture.

The oxide particles contained in the second raw material mixture are preferably blended so as to have molar ratios in the composition represented by the formula (II).

Specific examples of the fifth oxide particles include gadolinium oxide particles, terbium oxide particles, and lutetium oxide particles. Specific examples of the sixth oxide particles include aluminum oxide particles. Specific examples of the seventh oxide particles include gallium oxide particles and scandium oxide particles.

The second raw material mixture can be obtained by drying after the wet mixing. The drying temperature may be in a range of 50° C. or higher and 150° C. or lower, and the drying time may be in a range of 1 hour or more and 20 hours or less.

The second raw material mixture can be calcined at a temperature in a range of 1,000° C. or higher and 1,600° C. or lower to obtain rare earth aluminate particles. The resulting rare earth aluminate particles preferably have a composition included in a compositional formula represented by the formula (II). The second raw material mixture is preferably calcined under oxygen-containing atmosphere. The oxygen content in the atmosphere is preferably 5% by volume or more. The second raw material mixture may be calcined under an air atmosphere (oxygen content of 20% by volume or more). In an atmosphere with an oxygen content of less than 1% by volume, it may be difficult to dissolve the surface of each oxide and to form a crystal structure having a rare earth aluminate composition. The amount of oxygen in the atmosphere may be measured, for example, by the amount of oxygen flowing into the calcining apparatus, and may be measured at a temperature of 20° C. and atmospheric pressure (101.325 kPa). The pressure in calcining the second raw material mixture may be atmospheric pressure (101.325 kPa).

The rare earth aluminate particles obtained by calcining the second raw material mixture may be wet-crushed. The rare earth aluminate particles may be dry-pulverized and mixed. The rare earth aluminate particles may be dry-pulverized and mixed after wet crushing. The rare earth aluminate particles can be dispersed in a liquid, and wet-crushed using, for example, a ball mill. The rare earth aluminate particles can be dried at a temperature of 50° C. or higher and 150° C. or lower, and pulverized and mixed using, for example, a ball mill.

The method for producing a rare earth aluminate sintered body includes dry mixing a first raw material mixture obtained by wet mixing raw materials and then drying, and rare earth aluminate particles. Dry mixing is preferably performed for 10 minutes or more and 2 hours or less using, for example, a ball mill. After dry mixing, the mixture may be passed through a sieve with an aperture of 350 μm or less. When the first raw material mixture and the rare earth aluminate particles are dry-mixed, they are mixed less evenly than when they are wet-mixed. The dry-mixed first raw material mixture and rare earth aluminate particles, which are not as evenly mixed as when wet-mixed, can be calcined to form crystal agglomerated particles containing a rare earth aluminate fluorescent material crystal phase from the first raw material mixture, thereby obtaining a sintered body containing the rare earth aluminate particles arranged around the crystal agglomerated particles. The mixture containing the first raw material mixture and the rare earth aluminate particles may be dry powder mixed, in which a portion of the mixture is pulverized.

The content of the rare earth aluminate particles is preferably in a range of 1.0% by mass or more and 20.0% by mass or less, more preferably in a range of 1.2% by mass or more and 19.0% by mass or less, and even more preferably in a range of 1.5% by mass or more and 18.0% by mass or less, relative to 100% by mass of a total amount of the first raw material mixture and the rare earth aluminate particles. When the content of the rare earth aluminate particles falls within the range of 1.0% by mass or more and 20.0% by mass or less relative to 100% by mass of a total amount of the first raw material mixture and the rare earth aluminate particles, a sintered body in which the content of the rare earth aluminate crystal phase is in a range of 1.0% by volume or more and 10.0% by volume or less relative to 100% by volume of a total of the crystal agglomerated particles and the rare earth aluminate crystal phase can be obtained.

The method for producing a rare earth aluminate sintered body includes molding a mixture obtained by dry mixing. As the method for molding a mixture obtained by dry mixing, a known method such as a press molding method can be adopted. Examples of the press molding method include a die press molding method and a cold isostatic pressing (CIP) method for which the term is defined in No. 2109 of JIS Z2500:2000. Alternatively, it may be molded by uniaxial compression. Two types of molding methods may be adopted to shape the molded body. For example, CIP may be performed after die press molding, or CIP may be performed after uniaxial compression by a roller bench method. For CIP, the molded body is preferably pressed by a cold isostatic pressing method using water as a medium.

The pressure in die press molding or in molding by uniaxial compression is preferably in a range of 5 MPa or more and 50 MPa or less, and more preferably in a range of 5 MPa or more and 30 MPa or less. When the pressure in die press molding or in molding by uniaxial compression falls within the above-mentioned range, the molded body can be shaped to a desired shape.

The pressure in CIP is preferably in a range of 50 MPa or more and 200 MPa or less, and more preferably in a range of 50 MPa or more and 180 MPa or less. When the pressure in CIP falls within the range of 50 MPa or more and 200 MPa or less, a sintered body including crystal agglomerated particles containing a rare earth aluminate fluorescent material crystal phase, and a rare earth aluminate crystal phase arranged around the crystal agglomerated particles can be obtained.

The molded body obtained by molding the mixture may be heated to remove dispersants or the like for degreasing. When degreasing the molded body by heating, the molded body is preferably heated at a temperature in a range of 500° C. or higher and 1,000° C. or lower in an atmosphere of air and nitrogen. By heating the molded body at a temperature in a range of 500° C. or higher and 1,000° C. or lower in an atmosphere of air and nitrogen, the amount of carbon contained in the molded body is reduced, and a decrease in luminous flux due to the inclusion of carbon can be suppressed.

The method for producing a rare earth aluminate sintered body includes calcining the molded body obtained by molding. In calcining the molded body, the calcining temperature (temperature in the calcining furnace) is preferably in a range of 1,300° C. or higher and 1,800° C. or lower, more preferably in a range of 1,400° C. or higher and 1,790° C. or lower, even more preferably in a range of 1,450° C. or higher and 1,780° C. or lower, may be in a range of 1,500° C. or higher and 1,700° C. or lower, and may be in a range of 1,550° C. or higher and 1,650° C. or lower. When the calcining temperature is 1,300° C. or higher in calcining the molded body, a sintered body including crystal agglomerated particles containing a rare earth aluminate fluorescent material crystal phase, and a rare earth aluminate crystal phase arranged around the crystal agglomerated particles can be obtained. When the calcining temperature is 1,800° C. or lower in calcining the molded body, a sintered body in which grain boundaries of each crystal phase can be distinguished, without being dissolved and eliminated, by including voids dispersed around each crystal phase in the cross section of the rare earth aluminate sintered body can be obtained.

The calcining molded body is preferably performed under an oxygen-containing atmosphere. The oxygen content in the atmosphere is preferably 5% by volume or more, more preferably 10% by volume or more, and even more preferably 15% by volume or more. The molded body may be calcined under an air atmosphere (oxygen content of 20% by volume or more). In an atmosphere with an oxygen content of less than 1% by volume, it may be difficult to dissolve the surface of oxides, to form crystal agglomerated particles containing a rare earth aluminate fluorescent material crystal phase, and to arrange a rare earth aluminate crystal phase around the crystal agglomerated particles. The amount of oxygen in the atmosphere may be measured, for example, by the amount of oxygen flowing into the calcining apparatus, and may be measured at a temperature of 20° C. and atmospheric pressure (101.325 kPa). The pressure in calcining the molded body may be atmospheric pressure (101.325 kPa).

The resulting sintered body may be annealed in a reducing atmosphere. By annealing the resulting sintered body in a reducing atmosphere, cerium, which is an oxidized activation element contained in the rare earth aluminate fluorescent material crystal phase in the sintered body, is reduced, and a decrease in wavelength conversion efficiency and a decrease in luminous efficiency can be suppressed in each crystal phase. The reducing atmosphere may be an atmosphere containing a nitrogen gas or at least one rare gas selected from the group consisting of helium, neon, and argon, and a hydrogen gas or a carbon monoxide gas, and the atmosphere preferably contains at least argon or a nitrogen gas, and a hydrogen gas or a carbon monoxide gas. The annealing may be performed after processing.

The annealing temperature is lower than the calcining temperature, and is preferably in a range of 1,000° C. or higher and 1,600° C. or lower. The annealing temperature is more preferably in a range of 1,100° C. or higher and 1,400° C. or lower. When the annealing temperature is lower than the calcining temperature and falls within the range of 1,000° C. or higher and 1,600° C. or lower, cerium, which is an oxidized activation element contained in the rare earth aluminate fluorescent material crystal phase in the sintered body, is reduced, without reducing voids in the sintered body, and a decrease in wavelength conversion efficiency and a decrease in luminous flux can be suppressed.

The resulting sintered body may be processed by cutting into a desired size or thickness. Known methods can be used for the cutting method, and examples thereof include blade dicing, laser dicing, and cutting methods using a wire saw.

The resulting sintered body may be surface-treated. Surface treatment is performed on the surface of a cut product obtained by cutting the resulting sintere d body. With the surface treatment, the surface of the rare earth aluminate sintered body can be brought into an appropriate state for enhancing the light extraction efficiency, and the sintered body can be formed into a desired shape, size, or thickness in combination with the aforementioned processing or by the surface treatment alone. The surface treatment may be performed prior to processing of cutting the sintered body to a desired size or thickness, or may be performed after the processing. Examples of the surface treatment method include a method using sand-blasting, a method using mechanical grinding, a method using dicing, and a method using chemical etching.

With the production method described above, a rare earth aluminate sintered body including crystal agglomerated particles containing a rare earth aluminate fluorescent material crystal phase, and a rare earth aluminate crystal phase having a refractive index different from that of the rare earth aluminate fluorescent material crystal phase, in which the rare earth aluminate crystal phase is arranged around the crystal agglomerated particles, can be obtained. The rare earth aluminate fluorescent material crystal phase contained in the rare earth aluminate sintered body obtained by the production method described above preferably has a composition represented by the formula (I).

The obtained rare earth aluminate sintered body can be used as a wavelength conversion member by being combined with a light source, in light emitting devices such as light sources for projectors.

A light emitting device using the aforementioned rare earth aluminate sintered body as a wavelength conversion member will be described. The light emitting device includes the rare earth aluminate sintered body and an excitation light source.

The excitation light source is preferably a semiconductor light emitting element composed of an LED chip or an LD chip. The semiconductor light emitting element can use a nitride-based semiconductor. By using a semiconductor light emitting element as the excitation light source, a stable light emitting device having high efficiency, high output linearity with respect to input, and high resistance to mechanical impacts can be obtained. The rare earth aluminate sintered body converts the wavelength of light emitted from the semiconductor light emitting element, which allows a light emitting device capable of emitting wavelength-converted mixed color light to be constituted. The semiconductor light emitting element preferably emits light in a wavelength range of, for example, 350 nm or more and 500 nm or less. The rare earth aluminate sintered body preferably converts the wavelength of excitation light emitted from the semiconductor light emitting element to emit light having a light emission peak wavelength in a range of 500 nm or more and less than 650 nm.

The light emitting element is more preferably a laser diode. Excitation light emitted from a laser diode serving as the excitation light source is incident on the wavelength conversion member; light of which the wavelength is converted by the fluorescent material contained in the ceramic composite of the wavelength conversion member is converged and separated into red light, green light, and blue light by plural optical systems such as a lens array, a deflection conversion element, and a color separation optical system; and the lights may be modulated according to image information to thereby form color image lights. Excitation light emitted from a laser diode serving as the excitation light source may also be incident on the wavelength conversion member through an optical system such as a dichroic mirror or a collimating optical system.

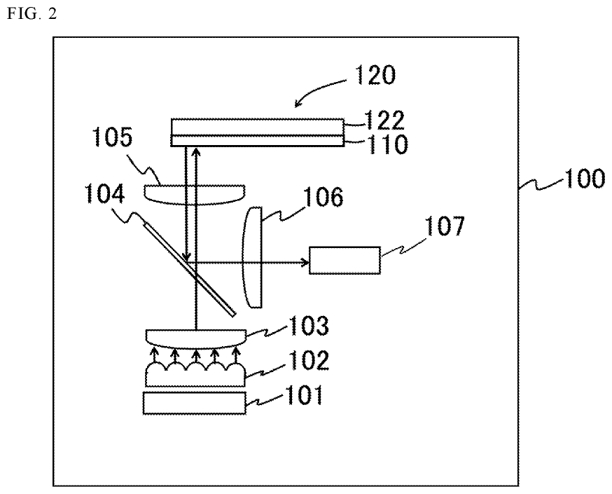

FIG. 2 shows a schematic diagram illustrating a configuration of an exemplary light emitting device 100. Arrows in FIG. 2 schematically represent optical paths of light. The light emitting device 100 preferably includes an excitation light source 101 which is a light emitting element, a collimating lens 102, three condenser lenses 103, 105, and 106, a dichroic mirror 104, a rod integrator 107, and a wavelength conversion device 120 including a wavelength conversion member. The excitation light source 101 preferably uses a laser diode. The excitation light source 101 may use a plurality of laser diodes, or a device in which a plurality of laser diodes are arranged in an array or matrix. The collimating lens 102 may be a collimating lens array in which a plurality of collimating lenses is arranged in an array. Laser light emitted from the excitation light source 101 is converted to substantially parallel light by the collimating lens 102, converged by the condenser lens 103, passed through the dichroic mirror 104, and further converged by the condenser lens 105. The laser light converged by the condenser lens 105 is wavelength-converted by the wavelength conversion device 120 including a wavelength conversion member 110 and a light reflection plate 122, and light having a light emission peak wavelength in a desired wavelength range is emitted from the wavelength conversion member 110 side of the wavelength conversion device 120. The wavelength-converted light emitted from the wavelength conversion device 120 is converged by the condenser lens 106, and is incident on the rod integrator 107, thereby emitting light having illuminance distribution with enhanced uniformity in a region to be illuminated from the light emitting device 100.

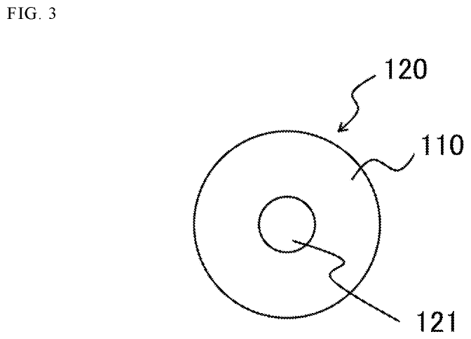

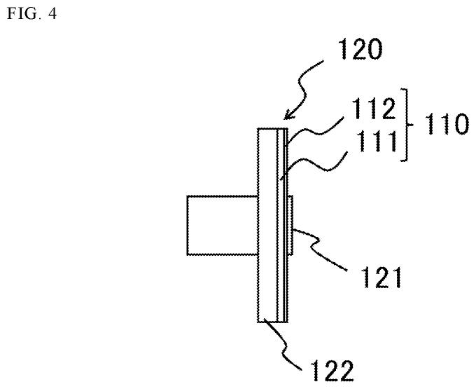

FIG. 3 shows a schematic diagram illustrating a planar configuration of an exemplary wavelength conversion device 120. FIG. 4 shows a lateral side view of the wavelength conversion device 120 as one of the members constituting a light emitting device 100. The wavelength conversion device 120 includes at least a wavelength conversion member 110. The wavelength conversion device 120 includes a disk-shaped wavelength conversion member 110, and may include a rotation mechanism 121 for rotating the wavelength conversion member 110. The rotation mechanism 121 can be connected to a drive mechanism such as a motor, to dissipate heat by rotating the wavelength conversion member 110.

FIG. 4 shows a schematic diagram showing a lateral side view configuration of an exemplary wavelength conversion device 120, which illustrates the details of the wavelength conversion device 120 shown in lateral side view as one of the members constituting a light emitting device 100 in FIG. 2. The wavelength conversion device 120 includes a rare earth aluminate sintered body 111 serving as a wavelength conversion member 110, and a light transmissive thin film 112. The wavelength conversion device 120 includes a light reflection plate 122 on the opposite side to the side where the light transmissive thin film 112 is arranged. If the light emitted from the rare earth aluminate sintered body 111 can be sufficiently emitted to the side where the light transmissive thin film 112 is arranged, the light reflection plate 122 can be omitted. The light reflection plate 122 may be used not only as a member for reflecting the light emitted from the rare earth aluminate sintered body 111 to the side where the light transmissive thin film 112 is arranged, but also as a heat dissipation member for dissipating heat generated in the rare earth aluminate sintered body 111 to the outside.

### EXAMPLES

The present disclosure is hereunder specifically described by reference to the following Examples. The present disclosure is not limited to the following Examples.

### Production Example of Raw Material Rare Earth Aluminate Fluorescent Material Particles (YAG Fluorescent Material Particles by Coprecipitation Method)

Yttrium chloride (YCl₃), cerium chloride (CeCl₃), and aluminum chloride (AlCl₃) were weighed so as to have a composition represented by Y_{2.99}Ce_{0.01}Al₅O₁₂, and dissolved in deionized water to provide a mixed solution. The mixed solution was charged into a solution of (NH₃)₂CO₃, and a mixture represented by Y_{2.99}Ce_{0.01}Al₅O₁₂ was obtained by a coprecipitation method. The mixture was placed in an alumina crucible, and calcined at a temperature in a range of 1,200° C. to 1,600° C. for 10 hours in an air atmosphere to obtain a calcined product. The resulting calcined product was passed through a dry sieve for classification, thereby providing a raw material YAG fluorescent material particles (coprecipitated YAG fluorescent material particles) having a composition represented by Y_{2.99}Ce_{0.01}Al₅O₁₂.

Yttrium oxide particles having an yttrium oxide purity of 98% by mass were used as the first oxide particles.

Cerium oxide particles having a cerium oxide purity of 92% by mass were used as the second oxide particles.

Aluminum oxide particles having an aluminum oxide purity of 99% by mass were used as the third oxide particles or the sixth oxide particles.

Gadolinium oxide particles having a gadolinium oxide purity of 98% by mass, terbium oxide particles having a terbium oxide purity of 98% by mass, and lutetium oxide particles having a lutetium oxide purity of 99% by mass were used as the fifth oxide particles.

### Example 1

Yttrium oxide particles as the first oxide particles, cerium oxide particles as the second oxide particles, aluminum oxide particles as the third oxide particles, and rare earth aluminate fluorescent material particles as the raw materials were weighed such that the molar ratios of Y, Al, and Ce elements contained in each of the oxide particles had a composition represented by Y_{2.988}Ce_{0.012}Al_{5.1}O₁₂. A dispersant (FLOWLEN G-700, manufactured by Kyoeisha Chemical Co., Ltd.) in an amount of 6.0 parts by mass was added to 100 parts by mass of the total amount of the first oxide particles, the second oxide particles, the third oxide particles, and the YAG fluorescent material particles obtained as the raw materials; 50 parts by mass of ethanol was further added thereto; and the materials were wet-mixed using a ball mill, dried at 130° C. for 10 hours; and then dry-pulverized and mixed using a ball mill to provide a first raw material mixture.

Gadolinium oxide particles as the fifth oxide particles and aluminum oxide particles as the sixth oxide particles were weighed such that the molar ratios of Gd and Al elements contained in each of the oxide particles had a composition represented by GdAlO₃. A dispersant (ESLEAM C-20931, manufactured by NOF Corp.) in an amount of 3.0 parts by mass was added to 100 parts by mass of the total amount of the fifth oxide particles and the sixth oxide particles; 50 parts by mass of ethanol was further added thereto; and the materials were wet-mixed using a ball mill; and then dried at 130° C. for 10 hours to provide a second raw material mixture. The second raw material mixture was calcined at 1,400° C. in an air atmosphere (oxygen content of 20% by volume or more, 101.325 kPa) to obtain a calcined product; and the resulting calcined product was dispersed in ethanol, wet-crushed using a ball mill, dried at 130° C., and then dry-pulverized and mixed using a ball mill to provide rare earth aluminate particles having a composition represented by GdAlO₃.

The resulting first raw material mixture and the resulting rare earth aluminate particles were dry-mixed for 20 minutes using a ball mill. The first raw material mixture and the rare earth aluminate particles were dry-mixed such that the content of the rare earth aluminate particles was 2.6% by mass relative to 100% by mass of the total of the first raw material mixture and the rare earth aluminate particles, and that the content of the rare earth aluminate crystal phase was the amount (% by volume) shown in Table 1 relative to 100% by volume of the total amount of the sintered body to be obtained, to obtain a mixture. The content (% by volume) of the rare earth aluminate crystal phase relative to the total amount of the rare earth aluminate sintered body can be calculated from the content (% by mass) of the rare earth aluminate particles relative to 100% by mass of the total amount of the first raw material mixture and the rare earth aluminate particles, as well as from the true density of the rare earth aluminate fluorescent material and the true density of the rare earth aluminate, which will be described later.

The resulting mixture was filled in a die to form a cylindrical molded body having a diameter of 26 mm and a thickness of 10 mm at a pressure of 5 MPa (51 kgf/cm²). The resulting cylindrical molded body was placed in a package container and vacuum-packed, and then subjected to cold isostatic pressing (CIP) at 176 MPa using a CIP apparatus (manufactured by Kobe Steel, Ltd. (KOBELCO)) to obtain a molded body. The resulting molded body was thermal-degreased at 700° C. in a nitrogen atmosphere.

The molded body obtained by molding was calcined using a calcining furnace (manufactured by Marusho Denki Co., Ltd.) to obtain a rare earth aluminate sintered body. The calcination was performed under the conditions of an air atmosphere (101.325 kPa, oxygen concentration of approximately 20% by volume), a temperature of 1,605° C., and a calcination time of 6 hours. The resulting rare earth aluminate sintered body was cut into an appropriate shape and size using a wire saw, and the surface of the cut product was polished using a surface grinder. Finally, a rare earth aluminate sintered body according to Example 1 having a plate thickness of 230 μm was obtained. The rare earth aluminate sintered body according to Example 1 included crystal agglomerated particles containing a rare earth aluminate fluorescent material crystal phase having a composition represented by Y_{2.988}Ce_{0.012}Al_{5.1}O₁₂, and a rare earth aluminate crystal phase having a composition represented by GdAlO₃. The refractive index of the rare earth aluminate fluorescent material crystal phase having a composition represented by Y_{2.988}Ce_{0.012}Al_{5.1}O₁₂ was 1.83, and the refractive index of the rare earth aluminate crystal phase having a composition represented by GdAlO₃ was 2.02.

### Example 2

A rare earth aluminate sintered body according to Example 2 was obtained in the same manner as in Example 1 except that the first raw material mixture and the rare earth aluminate particles were dry-mixed such that the content of the rare earth aluminate particles was 3.8% by mass relative to 100% by mass of the total of the first raw material mixture and the rare earth aluminate particles, and that the content of the rare earth aluminate crystal phase was the amount (% by volume) shown in Table 1 relative to 100% by volume of the total amount of the sintered body to be obtained, to obtain a mixture. The rare earth aluminate sintered body according to Example 2 included crystal agglomerated particles containing a rare earth aluminate fluorescent material crystal phase having a composition represented by Y_{2.988}Ce_{0.012}Al_{5.1}O₁₂, and a rare earth aluminate crystal phase having a composition represented by GdAlO₃.

### Example 3

Terbium oxide particles as the fifth oxide particles and aluminum oxide particles as the sixth oxide particles were weighed such that the molar ratios of Tb and Al elements contained in each of the oxide particles had a composition represented by TbAlO₃, to provide rare earth aluminate particles having a composition represented by TbAlO₃ in the same manner as in Example 1.

A rare earth aluminate sintered body according to Example 3 was obtained in the same manner as in Example 1 except that the first raw material mixture and the rare earth aluminate particles were dry-mixed such that the content of the rare earth aluminate particles was 2.6% by mass relative to 100% by mass of the total of the first raw material mixture and the rare earth aluminate particles, and that the content of the rare earth aluminate crystal phase was the amount (% by volume) shown in Table 1 relative to 100% by volume of the total amount of the sintered body to be obtained, to obtain a mixture. The rare earth aluminate sintered body according to Example 3 included crystal agglomerated particles containing a rare earth aluminate fluorescent material crystal phase having a composition represented by Y_{2.988}Ce_{0.012}Al_{5.1}O₁₂, and a rare earth aluminate crystal phase having a composition represented by TbAlO₃. The refractive index of the rare earth aluminate crystal phase having a composition represented by TbAlO₃ was 1.76.

### Example 4

A rare earth aluminate sintered body according to Example 4 was obtained in the same manner as in Example 3 except that the first raw material mixture and the rare earth aluminate particles were dry-mixed such that the content of the rare earth aluminate particles was 3.0% by mass relative to 100% by mass of the total of the first raw material mixture and the rare earth aluminate particles, and that the content of the rare earth aluminate crystal phase was the amount (% by volume) shown in Table 1 relative to 100% by volume of the total amount of the sintered body to be obtained, to obtain a mixture. The rare earth aluminate sintered body according to Example 4 included crystal agglomerated particles containing a rare earth aluminate fluorescent material crystal phase having a composition represented by Y_{2.988}Ce_{0.012}Al_{5.1}O₁₂, and a rare earth aluminate crystal phase having a composition represented by TbAlO₃. The refractive index of the rare earth aluminate crystal phase having a composition represented by TbAlO₃ was 1.95.

### Example 5

Lutetium oxide particles as the fifth oxide particles and aluminum oxide particles as the sixth oxide particles were weighed such that the molar ratios of Lu and Al elements contained in each of the oxide particles had a composition represented by LuAlO₃, to provide rare earth aluminate particles having a composition represented by LuAlO₃ in the same manner as in Example 1.

A rare earth aluminate sintered body according to Example 5 was obtained in the same manner as in Example 1 except that the first raw material mixture and the rare earth aluminate particles were dry-mixed such that the content of the rare earth aluminate particles was 4.4% by mass relative to 100% by mass of the total of the first raw material mixture and the rare earth aluminate particles, and that the content of the rare earth aluminate crystal phase was the amount (% by volume) shown in Table 1 relative to 100% by volume of the total amount of the sintered body to be obtained, to obtain a mixture. The rare earth aluminate sintered body according to Example 5 included crystal agglomerated particles containing a rare earth aluminate fluorescent material crystal phase having a composition represented by Y_{2.988}Ce_{0.012}Al_{5.1}O₁₂, and a rare earth aluminate crystal phase having a composition represented by LuAlO₃.

### Comparative Example 1

A rare earth aluminate sintered body according to Comparative Example 1 was obtained in the same manner as in Example 1 except that the rare earth aluminate particles were not used.

### Example 6

A mixture was obtained in the same manner as in Example 2 by dry mixing the first raw material mixture and the rare earth aluminate particles such that the content of the rare earth aluminate particles was 3.8% by mass relative to 100% by mass of the total of the first raw material mixture and the rare earth aluminate particles, and that the content of the rare earth aluminate crystal phase was the amount (% by volume) shown in Table 1 relative to 100% by volume of the total amount of the sintered body to be obtained; and a rare earth aluminate sintered body according to Example 6 was obtained in the same manner as in Example 2 except that the molded body obtained by molding the mixture was calcined at 1,610° C. The rare earth aluminate sintered body according to Example 6 included crystal agglomerated particles containing a rare earth aluminate fluorescent material crystal phase having a composition represented by Y_{2.988}Ce_{0.012}Al_{5.1}O₁₂, and a rare earth aluminate crystal phase having a composition represented by GdAlO₃.

### Example 7

A mixture was obtained by dry mixing the first raw material mixture and rare earth aluminate particles having a composition represented by TbAlO₃ obtained in the same manner as in Example 4; and a rare earth aluminate sintered body according to Example 7 was obtained in the same manner as in Example 6. The rare earth aluminate sintered body according to Example 7 included crystal agglomerated particles containing a rare earth aluminate fluorescent material crystal phase having a composition represented by Y_{2.988}Ce_{0.012}Al_{5.1}O₁₂; and a rare earth aluminate crystal phase having a composition represented by TbAlO₃.

### Example 8

A mixture was obtained by dry mixing the first raw material mixture and rare earth aluminate particles having a composition represented by LuAlO₃ obtained in the same manner as in Example 5 such that the content of the rare earth aluminate particles was 3.0% by mass relative to 100% by mass of the total of the first raw material mixture and the rare earth aluminate particles, and that the content of the rare earth aluminate crystal phase was the amount (% by volume) shown in Table 1 relative to 100% by volume of the total amount of the sintered body to be obtained; and a rare earth aluminate sintered body according to Example 8 was obtained in the same manner as in Example 6. The rare earth aluminate sintered body according to Example 8 included crystal agglomerated particles containing a rare earth aluminate fluorescent material crystal phase having a composition represented by Y_{2.988}Ce_{0.012}Al_{5.1}O₁₂, and a rare earth aluminate crystal phase having a composition represented by LuAlO₃.

### Example 9

A mixture was obtained by dry mixing the first raw material mixture and rare earth aluminate particles having a composition represented by LuAlO₃ obtained in the same manner as in Example 5; and a rare earth aluminate sintered body according to Example 9 was obtained in the same manner as in Example 6. The rare earth aluminate sintered body according to Example 9 included crystal agglomerated particles containing a rare earth aluminate fluorescent material crystal phase having a composition represented by Y_{2.988}Ce_{0.012}Al_{5.1}O₁₂, and a rare earth aluminate crystal phase having a composition represented by LuAlO₃.

### Comparative Example 2

A rare earth aluminate sintered body according to Comparative Example 2 was obtained in the same manner as in Example 6 except that the rare earth aluminate particles were not used.

### Comparative Example 3

A rare earth aluminate sintered body according to Comparative Example 3 was obtained in the same manner as in Example 1 except that aluminum oxide particles having an aluminum oxide purity of 99% by mass were used instead of the rare earth aluminate particles.

The rare earth aluminate sintered bodies, except for the rare earth aluminate sintered body according to Comparative Example 3, were evaluated as follows. The results are shown in Table 1. In Table 1, the symbol “-” indicates that there is no corresponding item or numerical value.

### Relative Density

The relative density of the rare earth aluminate sintered body according to each of Examples and Comparative Examples was measured. The relative density of the rare earth aluminate sintered body according to each of Examples and Comparative Examples was calculated by the above-mentioned formula (1). The apparent density of the rare earth aluminate sintered body was calculated by the above-mentioned formula (2). The true density of the rare earth aluminate sintered body was calculated by the above-mentioned formula (3). The true density of the rare earth aluminate fluorescent material was 4.60 g/cm³, the true density of GdAlO₃ was 7.24 g/cm³, the true density of TbAlO₃ was 7.39 g/cm³, and the true density of LuAlO₃ was 8.30 g/cm³.

### Relative Luminous Flux (%)

The rare earth aluminate sintered body according to each of Examples and Comparative Examples was irradiated with a laser light having a wavelength of 450 nm emitted from a laser diode such that the light diameter of the incident light was 2.2 mm, and the radiant flux of the light emitted from the same surface as that on which the laser light was incident was measured using an integral sphere. The radiant flux in Comparative Example 1 was defined as 100%, and the radiant flux obtained by measuring the sample of the rare earth aluminate sintered body according to each of Examples 1 to 9 and Comparative Example 2 relative to the radiant flux in Comparative Example 1 was expressed as a relative luminous flux (%).

### Light Diameter Ratio (Light Diameter of Emitting Light/Light Diameter of Incident Light)

The rare earth aluminate sintered body according to each of Examples and Comparative Examples was irradiated with a laser light having a wavelength of 450 nm emitted from a laser diode such that the light diameter of the incident light was 0.6 mm on the first main surface on which the laser light was incident, and the light diameter of the laser light was defined as the light diameter of the incident light incident on the first main surface of the rare earth aluminate sintered body. The light diameter of the emitting light emitted from the same surface as the first main surface on which the laser light was incident was determined as follows: light emission luminance of the light emitted from the rare earth aluminate sintered body according to each of Examples and Comparative Examples was measured using a color luminance meter; a position exhibiting the maximum luminance in the obtained light emission spectrum was defined as a center (measuring center); distances (mm) of two positions in the light emission spectrum where the luminance was 10/100 of the maximum luminance (10/100 luminance) from the measuring center were measured in terms of absolute values; and the sum of the absolute values of the distances (mm) of the two positions in the light emission spectrum where the luminance was 10/100 of the maximum luminance from the measuring center was determined as the light diameter of the emitting light emitted from the first main surface. The light diameter ratio of the light diameter of the emitting light emitted from the first main surface to the light diameter of the incident light incident on the same surface as the first main surface was determined. The light diameter ratio in Comparative Example 1 was defined as 100%, and the light diameter ratio obtained by measuring the sample of the rare earth aluminate sintered body according to each of Examples 1 to 9 and Comparative Example 2 relative to the light diameter ratio in Comparative Example 1 was expressed as a relative light diameter ratio (%).

### Light Extraction Efficiency (%)

For the rare earth aluminate sintered body according to each of Examples and Comparative Examples, the light extraction efficiency (%) was calculated by dividing the measured relative luminous flux by the relative light diameter ratio.

### Absolute Maximum Length Measurement Method

In SEM micrographs obtained by photographing the surface or cross section of the rare earth aluminate sintered body according to each of Examples and Comparative Examples using a scanning electron microscope (SEM), the region having an area of 1,209,675 μm² was defined as a measurement range. Here, the data size of each SEM micrograph was 640×480 (vertical×horizontal) pixels and one pixel was 1.984375 μm, and the area of the measurement range was thus calculated as 1,270 μm×952.5 μm, resulting in 1,209,675 μm². Secondary agglomerated particles of one rare earth aluminate fluorescent material crystal phase included in the measurement range was defined as crystal agglomerated particles, and the distance between the two most distant points on the outline of the crystal aggregate particles was measured as the absolute maximum length using Winroof 2018 image analysis software device (manufactured by Mitani Corp.). The absolute maximum lengths of 100 or more and 1,000 or less crystal agglomerated particles on the measurement area were measured, and the largest absolute maximum length value was defined as the absolute maximum length of the crystal agglomerated particles on the surface or cross-section of each rare earth aluminate sintered body. When the content of the rare earth aluminate particles was 1.7% by volume (Examples 1, 3, and 8), or when no rare earth aluminate particles were contained (Comparative Examples 1 and 2), the crystal agglomerated particles of the rare earth aluminate particles could not be separated and the separated grain boundary of the crystal agglomerated particles could not be measured.

### SEM Micrograph

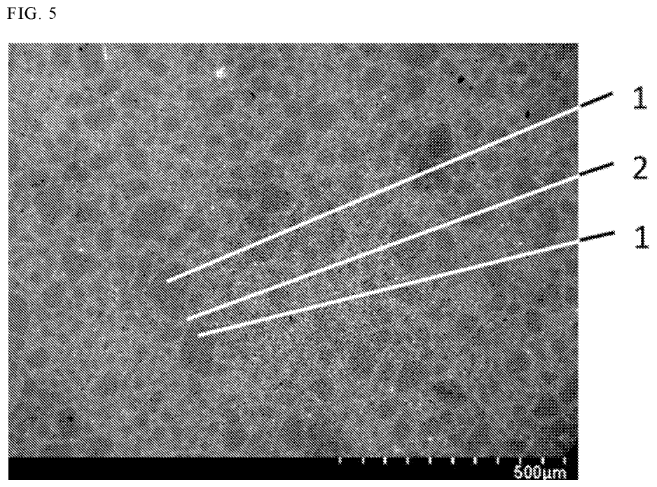

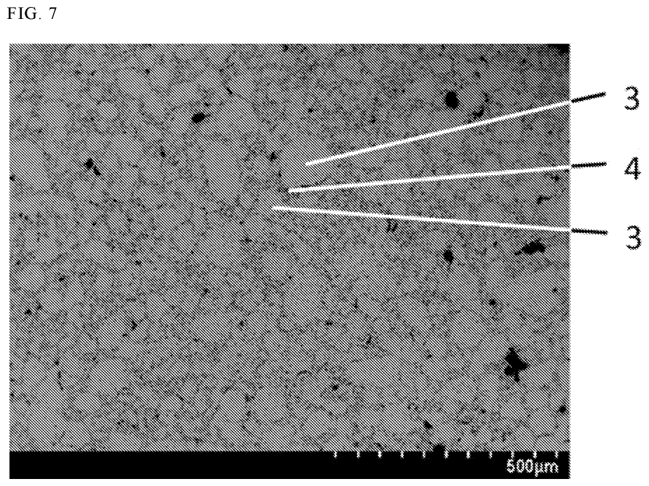

A scanning electron microscope (SEM) was used to obtain SEM micrographs of the surfaces of the rare earth aluminate sintered bodies according to Examples and Comparative Examples. The SEM micrographs shown in FIGS. were micrographs obtained at a magnification of 100 times, and the SEM micrographs used for measuring the absolute maximum length were also micrographs obtained at a magnification of 100 times in consideration of the accuracy of the analysis. FIG. 5 shows an SEM micrograph of the surface of the rare earth aluminate sintered body according to Example 3. FIG. 7 shows an SEM micrograph of the surface of the rare earth aluminate sintered body according to Comparative Example 3.

### Transmittance (%)

The transmittance was determined as follows using a spectrophotometer (Hitachi High-Tech Science Corp.): the light emitted from the light source was converted into monochromatic light having a wavelength of 550 nm using the spectrometer; the light intensity of the converted light having a wavelength of 550 nm was measured and defined as the incident light intensity; the light having a wavelength of 550 nm was incident on the rare earth aluminate sintered body according to each of Examples and Comparative Examples; the light intensity of the light emitted from the rare earth aluminate sintered body on the side opposite to the incident side was measured and defined as the transmitted light intensity; and the ratio of the transmitted light intensity to the incident light intensity was determined as the transmittance of the light having a wavelength of 550 nm, based on the following formula (4). In the formula (4), I₀ represents the incident light intensity and I represents the transmitted light intensity at each wavelength.

Transmittance (%)=I/I₀×100 (4)

### Transmission Spectrum

The transmission spectrum was obtained as follows using a spectrophotometer (Hitachi High-Tech Science Corp.): the light emitted from the light source was converted into monochromatic light at each wavelength using the spectrometer; the light intensity of the wavelength-converted light was measured and defined as the incident intensity; the light at each wavelength was incident on the rare earth aluminate sintered body according to each of Examples and Comparative Examples; the light intensity of the light emitted from the rare earth aluminate sintered body on the side opposite to the incident side was measured and defined as the transmitted light intensity; the ratio of the transmitted light intensity to the incident intensity was calculated based on the formula (4); and the transmittance at each wavelength was expressed as the transmission spectrum.

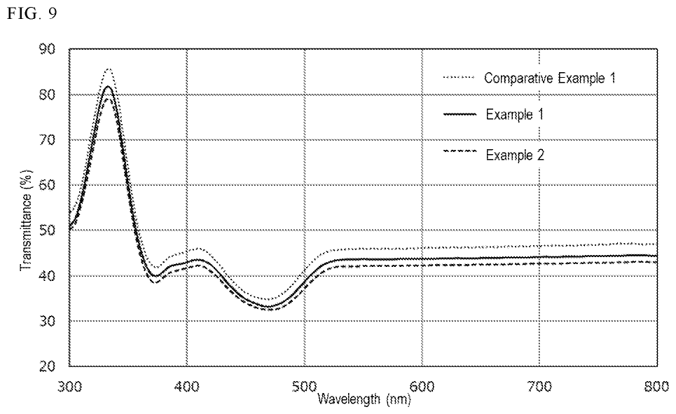

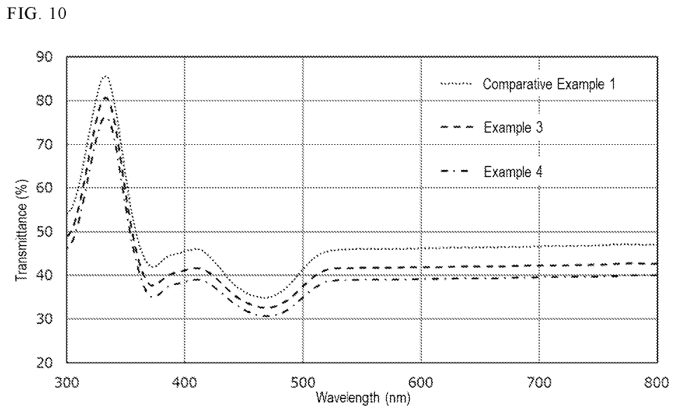

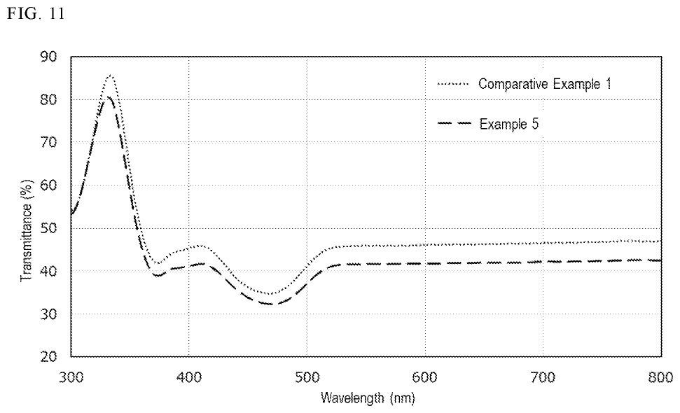

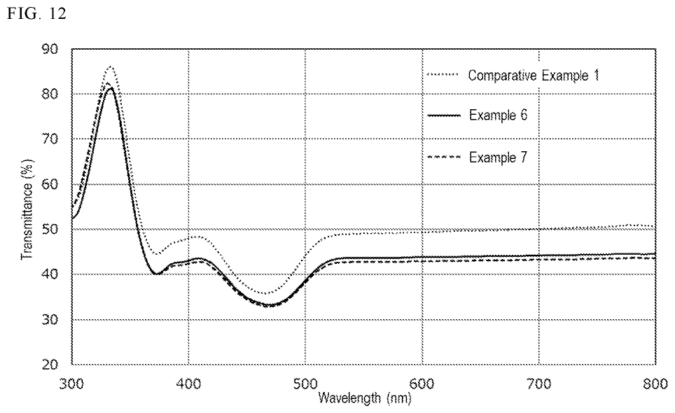

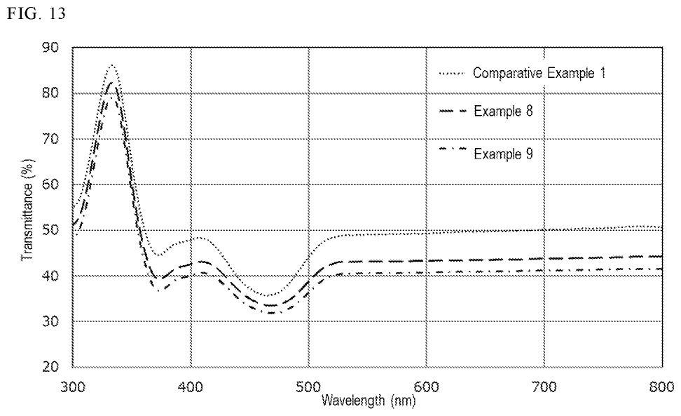

FIGS. 9 to 13 show the transmission spectra of the rare earth aluminate sintered bodies according to Examples 1 to 9 and Comparative Example 1.

TABLE 1

| | | Content of | | | | | Relative | Light extraction | Absolute |
|---|---|---|---|---|---|---|---|---|---|
| | | rare earth | | | Trans- | Relative | light | efficiency | maximum |
| | Rare earth | aluminate | Calcining | Relative | mittance | luminous | diameter | (luminous flux/ | length of crystal |
| | aluminate | crystal phase | temperature | density | 550 nm | flux | ratio | light diameter | agglomerated |
| | particles | (% by volume) | (° C.) | (%) | (%) | (%) | (%) | ratio) (%) | particles (μm) |
| Example 1 | GdAlO₃ | 1.7 | 1605 | 97.3 | 43.8 | 97.4 | 95.5 | 102.0 | — |
| Example 2 | GdAlO₃ | 2.5 | 1605 | 97.0 | 42.2 | 96.0 | 93.5 | 102.6 | 141.7 |
| Example 3 | TbAlO₃ | 1.7 | 1605 | 97.3 | 41.8 | 98.7 | 91.0 | 108.5 | — |
| Example 4 | TbAlO₃ | 2.5 | 1605 | 96.9 | 39.0 | 97.3 | 87.7 | 110.9 | 122.7 |
| Example 5 | LuAlO₃ | 2.5 | 1605 | 96.6 | 41.7 | 96.8 | 86.5 | 112.0 | 120.8 |
| Example 6 | GdAlO₃ | 2.5 | 1610 | 97.7 | 43.7 | 96.4 | 96.1 | 100.3 | 139.2 |
| Example 7 | TbAlO₃ | 2.5 | 1610 | 97.5 | 42.8 | 97.1 | 95.5 | 101.7 | 136.1 |
| Example 8 | LuAlO₃ | 1.7 | 1610 | 97.7 | 43.2 | 99.2 | 94.8 | 104.6 | — |
| Example 9 | LuAlO₃ | 2.5 | 1610 | 97.2 | 40.6 | 97.6 | 89.7 | 108.9 | 126.3 |
| Comparative | — | — | 1605 | 97.4 | 44.7 | 100.0 | 100.0 | 100.0 | — |
| Example 1 | | | | | | | | | |
| Comparative | — | — | 1610 | 98.4 | 46.0 | 101.1 | 107.1 | 94.4 | — |
| Example 2 | | | | | | | | | |

The rare earth aluminate sintered bodies according to Examples 2, 4 to 7, and 9 all had an absolute maximum length of the crystal agglomerated particles containing a rare earth aluminate fluorescent material crystal phase in the range of 10.0 μm or more and 150.0 μm or less. The rare earth aluminate sintered bodies according to Examples 1 to 9 had a relative light diameter ratio smaller than that of the rare earth aluminate sintered body according to Comparative Example 1, and the spread of the emitting light was suppressed. Although the relative luminous flux of the rare earth aluminate sintered bodies according to Examples 1 to 9 was lower than that of the rare earth aluminate sintered body according to Comparative Example 1, the light extraction efficiency was higher than in Comparative Example 1 since the relative light diameter ratio was small and the spread of the emitting light was suppressed. The rare earth aluminate sintered bodies according to Examples 1 to 9 had a lower transmittance at 550 nm than that of the rare earth aluminate sintered body according to Comparative Example 1 or 2, indicating that the light emitted from the light source was effectively utilized in the rare earth aluminate fluorescent material crystal phase.

The relative luminous flux of the rare earth aluminate sintered body according to Comparative Example 2 was higher than that of the sintered body according to Comparative Example 1. However, the light extraction efficiency was lowered since the relative light diameter ratio was larger than that of the sintered body according to Comparative Example 1 and the emitting light was spread.

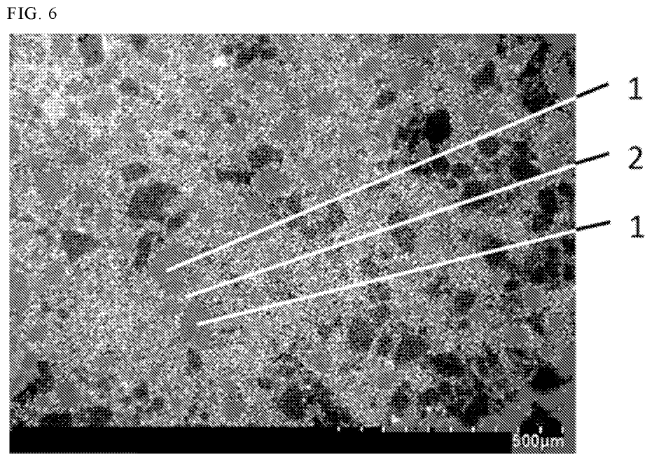

FIG. 5 shows an SEM micrograph of the surface of the rare earth aluminate sintered body according to Example 3. FIG. 6 shows an image view describing a state where grain boundaries of crystal agglomerated particles containing a rare earth aluminate fluorescent material crystal phase on the surface of the rare earth aluminate sintered body according to Example 3 are separated. On the surface of the rare earth aluminate sintered body according to Example 3, a rare earth aluminate crystal phase 2 having a composition represented by TbAlO₃, which had a refractive index different from that of the rare earth aluminate fluorescent material crystal phase, was arranged around the crystal agglomerated particles 1 containing the rare earth aluminate fluorescent material crystal phase. In the rare earth aluminate sintered body according to Example 3, two or more crystal agglomerated particles present 1 in one cross-sectional view (SEM micrograph of the surface of the rare earth aluminate sintered body), and a rare earth aluminate crystal phase 2 was arranged between the two crystal agglomerated particles 1. The rare earth aluminate sintered body according to Example 3 had a small relative light diameter ratio since the excitation light and the wavelength-converted light were scattered at the interface between the crystal agglomerated particles 1 and the rare earth aluminate crystal phase 2, and the spread of the light emitted from the sintered body was suppressed. The rare earth aluminate sintered body according to Example 3 had high light extraction efficiency since the spread of the light emitted from the rare earth aluminate sintered body was suppressed.

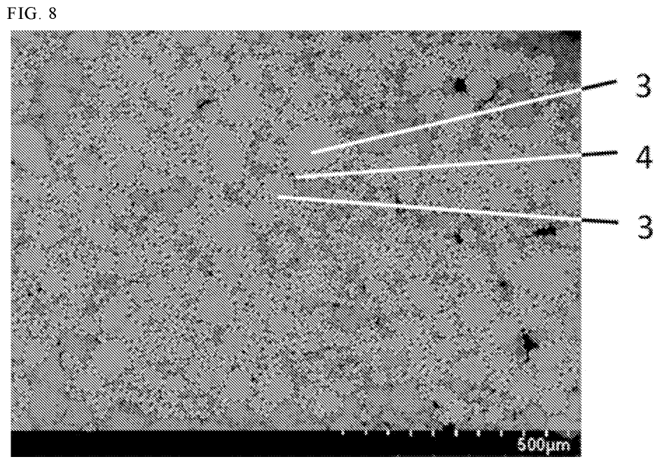

FIG. 7 shows an SEM micrograph of the surface of the rare earth aluminate sintered body according to Comparative Example 3. FIG. 8 shows an image view describing a state where grain boundaries of aluminum oxide crystal phases on the surface of the rare earth aluminate sintered body according to Comparative Example 3 are separated. The rare earth aluminate sintered body according to Comparative Example 3 included no rare earth aluminate crystal phase, and no crystal agglomerated particles containing a rare earth aluminate fluorescent material crystal phase were formed. The rare earth aluminate sintered body according to Comparative Example 3 formed aluminum oxide crystal phases 3, and a rare earth aluminate fluorescent material crystal phase 4 was arranged between the aluminum oxide crystal phases 3.

FIGS. 9 to 13 show the transmission spectra of the rare earth aluminate sintered bodies according to Examples 1 to 9 and Comparative Example 1. The transmission spectrum of each of the rare earth aluminate sintered bodies according to Examples 1 to 9 was lower than that of the rare earth aluminate sintered body according to Comparative Example 1, resulting in that the incident light was absorbed and efficiently wavelength-converted by the rare earth aluminate fluorescent material crystal phase, and the light extraction efficiency of the rare earth aluminate sintered bodies according to Examples 1 to 9 was increased.

Embodiments according to the present disclosure include the following rare earth aluminate sintered bodies and methods for producing the same.

### [Paragraph 1]

A rare earth aluminate sintered body including crystal agglomerated particles containing a rare earth aluminate fluorescent material crystal phase, and a rare earth aluminate crystal phase having a refractive index different from that of the rare earth aluminate fluorescent material crystal phase, wherein the rare earth aluminate crystal phase is arranged around the crystal agglomerated particles.

### [Paragraph 2]

The rare earth aluminate sintered body according to Paragraph 1, including two or more of the crystal agglomerated particles in one cross-sectional view, wherein the rare earth aluminate crystal phase is arranged between two or more of the crystal agglomerated particles.

### [Paragraph 3]

The rare earth aluminate sintered body according to Paragraph 1 or 2, wherein the rare earth aluminate crystal phase comprises and/or is derived from primary particles of a rare earth aluminate.

### [Paragraph 4]

The rare earth aluminate sintered body according to any one of Paragraph 1 to 3, wherein the crystal agglomerated particles have an absolute maximum length in a range of 10.0 μm or more and 150.0 μm or less on a surface or cross section of the rare earth aluminate sintered body.

### [Paragraph 5]

The rare earth aluminate sintered body according to any one of Paragraph 1 to 4, wherein the rare earth aluminate fluorescent material crystal phase contains at least one element selected from the group consisting of Y, La, Gd, Tb, and Lu.

### [Paragraph 6]

The rare earth aluminate sintered body according to any one of Paragraph 1 to 5, wherein the rare earth aluminate crystal phase contains at least one element selected from the group consisting of Gd, Tb, and Lu.

### [Paragraph 7]

The rare earth aluminate sintered body according to Paragraph 4, wherein a measurement range area of the rare earth aluminate sintered body for measuring the absolute maximum length of the crystal agglomerated particles is an area of 1,209,675 μm² in an SEM micrograph measured using a scanning electron microscope.

### [Paragraph 8]

The rare earth aluminate sintered body according to any one of Paragraph 1 to 7, wherein a content of the rare earth aluminate crystal phase is in a range of 1.0% by volume or more and 10.0% by volume or less relative to 100% by volume of a total volume of the crystal agglomerated particles and the rare earth aluminate crystal phase.

### [Paragraph 9]

The rare earth aluminate sintered body according to any one of Paragraph 1 to 8, wherein the rare earth aluminate fluorescent material crystal phase has a composition represented by the following formula (I):

(R¹₁₋ₙCeₙ)₃(Al₁₋ₘM¹m)₅ₖO₁₂ (I)

wherein R¹ represents at least one element selected from the group consisting of Y, La, Lu, Gd, and Tb; M¹ represents at least one element selected from the group consisting of Ga and Sc; and m, n, and k each satisfy 0≤m≤0.02, 0.002≤n≤0.017, and 0.95≤k≤1.10.

### [Paragraph 10]

The rare earth aluminate sintered body according to any one of Paragraph 1 to 9, wherein the rare earth aluminate crystal phase has a composition represented by the following formula (II):

R²Al₁₋ⱼM²ⱼO₃ (II)

wherein R² represents at least one element selected from the group consisting of Gd, Tb, and Lu; M² represents at least one element selected from the group consisting of Ga and Sc; and j satisfies 0≤j≤0.02.

### [Paragraph 11]

A method for producing a rare earth aluminate sintered body including: providing a first raw material mixture obtained by wet mixing raw materials and then drying; dry mixing the first raw material mixture and rare earth aluminate particles; molding a mixture obtained by dry mixing the first raw material mixture and the rare earth aluminate particles; and calcining a molded body obtained by molding the mixture.

### [Paragraph 12]

The method for producing a rare earth aluminate sintered body according to Paragraph 11, wherein the first raw material mixture is provided to contain first oxide particles containing at least one element R′ selected from the group consisting of Y, La, Lu, Gd, and Tb, second oxide particles containing Ce, third oxide particles containing Al, optionally fourth oxide particles containing at least one element M′ selected from the group consisting of Ga and Sc, and optionally rare earth aluminate fluorescent material particles.

### [Paragraph 13]

The method for producing a rare earth aluminate sintered body according to Paragraph 11 or 12, wherein the rare earth aluminate particles are provided by wet mixing fifth oxide particles containing at least one element R² selected from the group consisting of Gd, Tb, and Lu, sixth oxide particles containing Al, and optionally seventh oxide particles containing an element M² selected from the group consisting of Ga and Sc, and calcining a second raw material mixture obtained by the wet mixing at a temperature in a range of 1,000° C. or higher and 1,600° C. or lower.

### [Paragraph 14]

The method for producing a rare earth aluminate sintered body according to any one of Paragraph 11 to 13, wherein the molded body is calcined at a calcining temperature in a range of 1,300° C. or higher and 1,800° C. or lower.

The rare earth aluminate sintered body according to the present disclosure can be used, in combination with an excitation light source, as a wavelength conversion member for lighting devices for vehicles and general lighting, backlights for liquid crystal display devices, and light sources for projectors.

What is claimed is:

1. A rare earth aluminate sintered body comprising:
crystal agglomerated particles containing a rare earth aluminate fluorescent material crystal phase, and
a rare earth aluminate crystal phase having a refractive index different from a refractive index of the rare earth aluminate fluorescent material crystal phase, wherein the rare earth aluminate crystal phase is arranged around the crystal agglomerated particles.

2. The rare earth aluminate sintered body according to claim 1, wherein two or more of the crystal agglomerated particles are present in a cross-sectional view, and wherein the rare earth aluminate crystal phase is arranged between the two or more of the crystal agglomerated particles.

3. The rare earth aluminate sintered body according to claim 1, wherein the rare earth aluminate crystal phase comprises and/or is derived from primary particles of a rare earth aluminate.

4. The rare earth aluminate sintered body according to claim 1, wherein the crystal agglomerated particles have an absolute maximum length in a range of 10.0 μm or more and 150.0 μm or less on a surface or a cross section of the rare earth aluminate sintered body.

5. The rare earth aluminate sintered body according to claim 1, wherein the rare earth aluminate fluorescent material crystal phase comprises at least one element selected from the group consisting of Y, La, Gd, Tb, and Lu.

6. The rare earth aluminate sintered body according to claim 1, wherein the rare earth aluminate crystal phase comprises at least one element selected from the group consisting of Gd, Tb, and Lu.

7. The rare earth aluminate sintered body according to claim 4, wherein a measurement range area of the rare earth aluminate sintered body for measuring the absolute maximum length of the crystal agglomerated particles is an area of 1,209,675 μm² in an SEM micrograph measured using a scanning electron microscope.

8. The rare earth aluminate sintered body according to claim 1, wherein a content of the rare earth aluminate crystal phase is in a range of 1.0% by volume or more and 10.0% by volume or less relative to 100% by volume of a total volume of the crystal agglomerated particles and the rare earth aluminate crystal phase.

9. The rare earth aluminate sintered body according to claim 1, wherein the rare earth aluminate fluorescent material crystal phase has a composition represented by the following formula (I):
(R¹₁₋ₙCeₙ)₃(Al₁₋ₘM¹ₘ)₅ₖO₁₂ (I)
wherein R¹ represents at least one element selected from the group consisting of Y, La, Lu, Gd, and Tb; M¹ represents at least one element selected from the group consisting of Ga and Sc; and m, n, and k each satisfy 0≤m≤0.02, 0.002≤n≤0.017, and 0.95≤k≤1.10.

10. The rare earth aluminate sintered body according to claim 1, wherein the rare earth aluminate crystal phase has a composition represented by the following formula (II):
R²Al₁₋ⱼM²ⱼO₃ (II)
wherein R² represents at least one element selected from the group consisting of Gd, Tb, and Lu; M² represents at least one element selected from the group consisting of Ga and Sc; and j satisfies 0≤j≤0.02.

11. A method for producing a rare earth aluminate sintered body comprising:
providing a first raw material mixture obtained by wet mixing raw materials and then drying;
dry mixing the first raw material mixture and rare earth aluminate particles to obtain a mixture;
molding the mixture to obtain a molded body; and
calcining the molded body.

12. The method according to claim 11, wherein the first raw material mixture comprises first oxide particles containing at least one element R′ selected from the group consisting of Y, La, Lu, Gd, and Tb, second oxide particles containing Ce, third oxide particles containing Al, optionally fourth oxide particles containing at least one element M′ selected from the group consisting of Ga and Sc, and optionally rare earth aluminate fluorescent material particles.

13. The method according to claim 11, wherein the rare earth aluminate particles are provided by:
wet mixing oxide particles containing at least one element R² selected from the group consisting of Gd, Tb, and Lu, oxide particles containing Al, and optionally oxide particles containing an element M² selected from the group consisting of Ga and Sc to obtain a second raw material mixture, and
calcining the second raw material mixture.

14. The method for producing a rare earth aluminate sintered body according to claim 11, wherein the molded body is calcined at a calcining temperature in a range of 1,300° C. or higher and 1,800° C. or lower.
